(19) United States
(12) Patent Application Publication
(10) Pub. No.: US 2017/0364360 A1
(43) Pub. Date: Dec. 21, 2017

(54) POWER TOOL ANTI-THEFT

(71) Applicant: Infineon Technologies Austria AG, Villach (AT)

(72) Inventors: Renato Bessegato, Oberhaching (DE); Mohit Berry, Munich (DE)

(21) Appl. No.: 15/184,799

(22) Filed: Jun. 16, 2016

(51) Int. Cl. G06F 9/32; B25F 5/00; G05B 19/048

(52) U.S. Cl. CPC G06F 9/32; G05B 19/048; B25F 5/00; G05B 2219/24167

(57) ABSTRACT

Techniques are disclosed for providing anti-theft protection for power tools. In one example of the techniques of the disclosure, at least one processor of a power tool receives, from an operator, a command to operate the power tool. In response to receiving the command, the at least one processor determines whether at least one of a value of a master authentication counter of the power tool and a value of a user authentication counter of the power tool has reached a predetermined threshold. In response to determining that the at least one of the value of the master authentication counter and the value of the user authentication counter has reached a predetermined threshold, the at least one processor disables the power tool.

### TECHNICAL FIELD

This disclosure generally relates to anti-theft protection techniques for power tools.

### BACKGROUND

Tools, such as battery-powered power tools, are used in construction sites or are rented out to home users. Frequently, these tools are expensive and require substantial investment by the owner. However, because these tools are often portable, cordless, and moved around the worksite, these tools may be vulnerable to theft. For example, an employee at a work site may check out a tool from a storage locker, and take the tool home at the end of the work day. Alternatively, an employee at a work site may leave the tool at the work site. A thief may steal the tool, while no employees are guarding the work site. Furthermore, a hardware store may rent power tools to consumers, and the consumer may steal the device, instead of returning it to the store after the rental period. These stolen tools may subsequently be sold on a secondary market for a large amount of cash, thus incentivizing the theft of these power tools. Thus, the rightful owner of the tools may incur substantial costs to replace stolen tools as a matter of course in his business.

### SUMMARY

In general, the disclosure describes techniques for providing anti-theft protection for power tools. Specifically, the disclosure describes a methodology wherein a power tool disables itself after a predetermined amount of usage time, and re-enables usage only after secure, software-based authentication of the device. In some examples, the power tool includes a master counter and a user counter. While the master counter and the user counter are greater than zero, the power tool functions normally. The master counter and user counter are decremented during the use of the device, such that, when either of the counters expire, the power tool disables itself until the counters are reset by an external device. In some examples, the user counter is set to last a particular shift duration, such as an eight-hour working day or 24-hour period, while the master counter is set to last a longer duration, such as one or two weeks. Each of the counters is reset by a corresponding authentication key. In some examples, the key is provided by wirelessly synchronizing the power tool with an external device, such as a rechargeable battery pack, docking cradle, or charger for the power tool. In some examples, each of a plurality of rechargeable battery pack provides a unique user key capable of resetting the user counter but not the master counter of the power tool. In further examples, a docking cradle provides a unique master key capable of resetting both the master counter and the user counter of the power tool.

Accordingly, the techniques of the disclosure allow for a power tool to disable itself and prevent further use without further authorization from the owner. Such a power tool may deter or prevent theft by rendering the power tool useless after a certain amount of time without a secure connection to equipment of the owner to re-enable the functionality of the device. Furthermore, the techniques of the disclosure provide for a software-based system that provides several advantages over other devices. For example, the power tool of the disclosure does not require a small, detachable security device that may be easily lost or misplaced, accelerate wear on the tool, or deposit dirt, water, or contamination into the inner workings of the device. Furthermore, the power tool of the present disclosure may refresh its permissions upon automatically connecting to the external device, and therefore simplifies the implementation of anti-theft procedures by eliminating the involvement of the end-user.

In one example, this disclosure describes a method including: receiving, by at least one processor of a power tool and from an operator, a command to operate the power tool; in response to receiving the command, determining, by the at least one processor, whether at least one of a value of a master authentication counter of the power tool and a value of a user authentication counter of the power tool has reached a predetermined threshold; and in response to determining that the at least one of the value of the master authentication counter and the value of the user authentication counter has reached a predetermined threshold, disabling, by the at least one processor, the power tool.

In another example, this disclosure describes a power tool, including: a memory, configured to store a value of a master authentication counter and a value of a user authentication counter; and at least one processor configured to: receive, from an operator, a command to operate the power tool; in response to receiving the command, determine whether at least one of the value of the master authentication counter and the value of the user authentication counter has reached a predetermined threshold; and in response to determining that the at least one of the value of the master authentication counter and the value of the user authentication counter has reached a predetermined threshold, disable the power tool.

In another example, this disclosure describes a system, including: a power tool, including: a memory, configured to store a value of a master authentication counter and a value of a user authentication counter; and at least one processor configured to: receive, from an operator, a command to operate the power tool; in response to receiving the command, determine whether at least one of the value of the master authentication counter and the value of the user authentication counter has reached a predetermined threshold; and in response to determining that the at least one of the value of the master authentication counter and the value of the user authentication counter has reached a predetermined threshold, disable the power tool; a first external device configured to: store a master software key in a first memory; and transmit the master software key to the power tool; wherein the at least one processor of the power tool is further configured to: receive the master software key; validate the master software key; and in response to validating the master software key, reset the value of the master authentication counter and the value of the user authentication counter; and a second external device configured to: store a user software key in a second memory; and transmit the user software key to the power tool; wherein the at least one processor of the power tool is further configured to: receive the user software key; validate the user software key; and in response to validating the user software key, reset the value of the user authentication counter but not the value of the master authentication counter.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system for providing anti-theft techniques for a power tool according to the techniques of the disclosure.

FIG. 2 is a block diagram providing further detail of the example power tool of FIG. 1 according to the techniques of the disclosure.

FIG. 3 is an illustration providing further detail of the example docking cradle of FIG. 1 according to the techniques of the disclosure.

FIG. 4 is a block diagram providing further detail of the example docking cradle of FIG. 1 according to the techniques of the disclosure.

FIG. 5 is a block diagram providing further detail of the example detachable battery pack of FIG. 1 according to the techniques of the disclosure.

FIG. 6 is a graph illustrating an example operation for providing anti-theft techniques for the power tool of FIG. 1 according to the techniques of the disclosure.

FIG. 7 is a flowchart illustrating an example operation for providing anti-theft techniques for the power tool of FIG. 1 according to the techniques of the disclosure.

### DETAILED DESCRIPTION

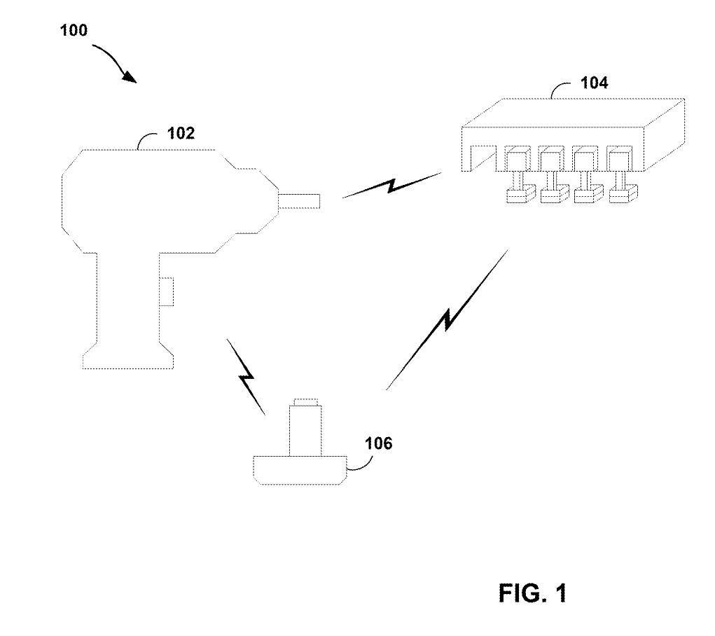

FIG. 1 is a block diagram illustrating an example system 100 for providing anti-theft techniques for a power tool 102 according to the techniques of the disclosure. In one example, system 100 includes a power tool 102 that receives power from a detachable battery pack 106. One or more power tools, including power tool 102, are configured to dock with docking cradle 104. Further, external devices, such as docking cradle 104 and detachable battery pack 106, communicate with power tool 102 to provide security and authorization protocols to deter theft of power tool 102.

Power tool 102 is a tool that is actuated by a power source and mechanism other than via the manual effort of the operator. Power tool 102 typically performs work via an electric motor or gasoline engine, but may be driven via pneumatic or hydraulic power or some other suitable means. In some examples, power tool 102 receives electrical power via solar power, an electric battery, an electric cord, or some combination thereof. In some examples, power tool 102 is a handheld or portable device. Typically, examples of power tool 102 are found in a variety of applications, such as industrial production, construction, gardening, landscaping, farming, metalworking, woodworking, vehicle repair, or household maintenance and improvement. Examples of power tool 102 include an air compressor, alligator shears, an angle grinder, a band saw, a belt sander, a biscuit joiner, a tile cutter, a chainsaw, a circular saw, a concrete saw, a cold saw, a crusher, a diamond blade, a diamond tool, a disc cutter, a disc sander, a drill, a floor sander, a food processor, a grinding machine, a heat gun, a hedge trimmer, an impact driver, an impact wrench, a jackhammer, a joint plane, a jointer, a jigsaw, a knitting machine, a lathe, a lawn mower, a leaf blower, a master tool, a miter saw, a multi-tool, a nail gun (electric, battery, or powder actuated), a needle scaler, a pneumatic torque wrench, a powder-actuated tool, a power wrench, a radial arm saw, a random orbital sander, a reciprocating saw, a rotary reciprocating saw, a rotary tool, a rotovator, a sabre saw, a sander, a scrollsaw, a sewing machine, a steel cut-off saw, a strimmer, a string trimmer, a table saw, a thickness planer, a vacuum cleaner, a wall chaser, or a wood router. However, the techniques of the disclosure apply to other types of power tools not specifically described herein.

Detachable battery pack 106 provides electrical power to power tool 102. In some examples, detachable battery pack 106 includes a battery, such as an Alkaline, Zinc-Carbon, Lead-Acid, Mercury, Lithium Ion, Lithium Polymer, Silver Oxide, Nickel-Cadmium, Nickel-Metal Hydride, or Nickel-Zinc battery. The housing of detachable battery pack 106 is configured to adapt to the housing of power tool 102 such that detachable battery pack 106 may securely attach to power tool 102. While connected to power tool 102, detachable battery pack 106 establishes an electrical connection such that detachable battery pack 106 supplies electrical power to power tool 102. Typically, detachable battery pack 106 is rechargeable, such that an operator may possess numerous spare battery packs for a single power tool 102. When the charge of a first detachable battery pack 106 is depleted, the operator may replace the battery pack with a second, charged battery pack to continue operation of power tool 102. In some examples, an operator recharges detachable battery pack 106 by connecting detachable battery pack 106 to a battery charger configured to adapt alternating current (AC) from an external power source into a form usable by detachable battery pack 106. In some examples, detachable battery pack 106 provides power regulation, monitoring, and electrical safety operations for power tool 102.

Docking cradle 104 is a device configured to provide storage for one or more power tools, such as power tool 102. In some examples, docking cradle 104 is configured to one or more power tools 102. In some examples, docking cradle 104 provides electrical charging functions for one or more detachable battery packs 106 or one or more power tool 102 adapted to a detachable battery pack 106. In some examples, docking cradle 104 is stored within an office, headquarters, or warehouse of the owner of power tool 102 to provide inventory control of the one or more power tools 102 and detachable battery packs 106. For example, docking cradle 104 may provide a means for locking or securing the one or more power tools 102 and detachable battery packs 106 within docking cradle 104 when the one or more power tools 102 and detachable battery packs 106 are not in use.

According to the techniques of the disclosure, after a predetermined amount of usage time, power tool 102 disables itself. After disabling itself, power tool 102 no longer functions until power tool 102 is re-enabled via secure, software-based authentication. In some examples, power tool 102 may only be re-enabled via communication with an external device, such as detachable battery pack 106 or docking cradle 104. Thus, power tool 102 periodically disables itself to prevent further use without further authorization from the owner of power tool 102.

In one example, power tool 102 includes a master counter and a user counter. While each of the master counter and the user counter are greater than zero, the power tool functions normally. The master counter and user counter are decremented during the use of the device, such that, when either of the counters expire, power tool 102 disables itself until the counters are reset. In some examples, the user counter is set to last a particular shift duration, such as an eight-hour working day or 24-hour period, while the master counter is set to last a longer duration, such as one or two weeks. Each of the counters is reset by a corresponding authentication key. In some examples, the authentication key is provided by wirelessly synchronizing the power tool 102 with an external device, such as a rechargeable battery pack, docking cradle, or charger for power tool 102. In some examples, each of a plurality of rechargeable battery packs 106 provides a unique user key capable of resetting the user counter but not the master counter of power tool 102. In further examples, docking cradle 104 provides a unique master key capable of resetting both the master counter and the user counter of the power tool 102. However, in other examples, other devices provide one or both of the user authentication key and the master authentication key. In some examples, power tool 102 receives the authentication keys via a wired connection or a wireless connection to the external device.

Accordingly, the techniques of the disclosure allow for power tool 102 to disable itself after a predetermined amount of time and prevent further use without further authorization from the owner. Therefore, power tool 102 may deter or prevent theft by rendering power tool 102 useless after a certain amount of time without a secure connection to equipment of the owner to re-enable the functionality of the device. Furthermore, the techniques of the disclosure provide for a software-based system that provides several advantages over other devices. For example, the power tool of the disclosure does not require a small, detachable security device that may be easily lost or misplaced, accelerate wear on the tool, or deposit dirt, water, or contamination into the inner workings of the device. Furthermore, the power tool of the present disclosure may refresh its permissions upon automatically connecting to the external device, and therefore simplifies the implementation of anti-theft procedures by eliminating the involvement of the end-user.

The architecture of system 100 illustrated in FIG. 1 is shown as an example. The techniques as set forth in this disclosure may be implemented in the example architecture of FIG. 1, as well as other architectures not described specifically herein. Nothing in this disclosure should be construed so as to limit the techniques of this disclosure to the example architecture illustrated by FIG. 1.

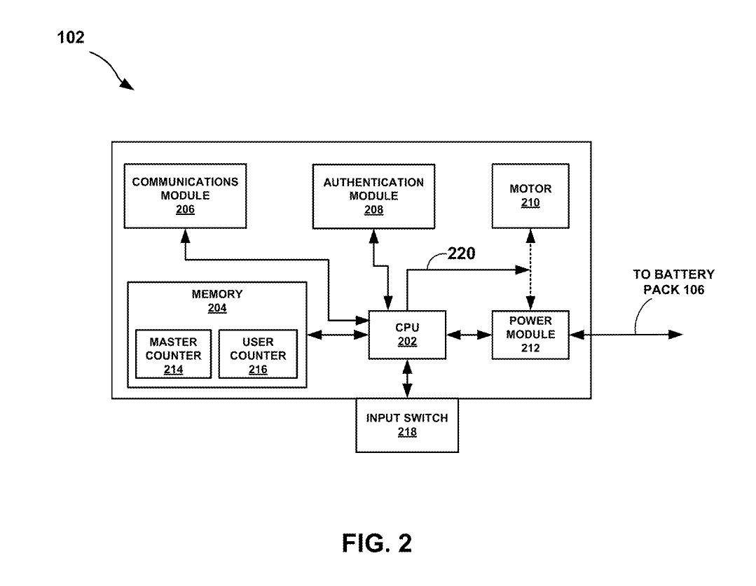

FIG. 2 is a block diagram providing further detail of the example power tool 102 of FIG. 1 according to the techniques of the disclosure. In the example of FIG. 2, power tool 102 includes one or more processors 202 and a memory 204 including at master counter 214 and a user counter 216. An operator may depress input switch 218 to activate motor 210 of power tool 102. However, when one of master counter 214 and user counter 216 expire, processors 202 deactivates power tool 102. Processors 202 re-enable power tool 102 upon receiving authentication keys via communications module 206.

Power tool 102 includes a motor 210. In the example of FIG. 2, motor 210 is an electric motor. However, in other examples, power tool 102 has a gasoline- or kerosene-powered motor, a steam engine, or operates via pneumatic or hydraulic pressure. Motor 210 provides operative force for power tool 102 to perform its desired operation on a target indicated by the operator.

In the example of FIG. 2, power tool 102 further includes a power module 212. Power module 212 receives electrical power from detachable battery pack 106 and supplies power to processors 202, motor 210, and the other components of power tool 102. In some examples, power module 212 includes power regulation circuitry to prevent damage to power tool 102 by a defect or malfunction in detachable battery pack 106. For example, power module 212 operates to electrically isolate power tool 102 from detachable battery pack 106 and to prevent short circuits or oversupply of electrical current or voltage. In some examples, power module 212 may perform voltage conversion functions on power received from battery pack 106 to supply a first voltage or current to processors 202 and a second voltage or current to motor 210. In some examples, power module 212 protects motor 210 from damage by decoupling it from power in response to determining that motor 210 is overheating, operating too quickly, or otherwise operating in an unsafe or unintended manner.

In some examples, processors 202 may be microprocessors, digital signal processors (DSPs), application specific integrated circuits (ASICs), field programmable gate arrays (FPGAs), or any other equivalent integrated or discrete logic circuitry, as well as any combinations of such components. Further, memory 204 may be random access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. Further, this memory may be implanted entirely in hardware, software, or a combination thereof.

In one example, memory 204 includes a master counter 214 and a user counter 216, each of which may act as timers. In one example, processors 202 decrement each of master counter 214 and user counter 216 according to real calendar time. In other examples, processors 202 decrement each of master counter 214 and user counter 216 while power tool 102 is operating or in use. In some examples, each of master counter 214 and user counter 216 indicate a time remaining before processors 202 disable power tool 202. For example, each of master counter 214 and user counter 216 may indicate an amount of milliseconds, seconds, minutes, hours, days, or the like before power tool 102 is disabled. While in the example described above, master counter 214 and user counter 216 are count-down counters, other structures may be used to implement the techniques of the disclosure. For example, master counter 214 and user counter 216 may be count-down counters, count-up counters, registers to which a predetermined value is compared, timers, or other suitable device implemented in hardware, software, or a combination of the two.

In some examples, power tool 102 receives one or more a master or user authentication keys from an external device via communications module 206. Communication module 206 includes any suitable circuitry, firmware, software, or any combination thereof for communicating with another external device, such as detachable battery pack 106 or docking cradle 104 of FIG. 1. In some examples, communication module 206 connects to an external device via a wired or a wireless connection. For example, communication module 206 may include one or more antennae, modulation and demodulation circuitry, filters, amplifiers, or the like for radio frequency communication with other external devices, such as detachable battery pack 106 or docking cradle 104. Under the control of processors 202, communication module 206 may receive downlink telemetry from and send uplink telemetry to an external device with the aid of an antenna, which may be internal and/or external. Processors 202 may provide the data to be uplinked to the external device and the control signals for the telemetry circuit within communication module 206, e.g., via an address/data bus. In some examples, communication module 206 provides received data to processors 202 via a multiplexer, e.g., for example, in implementations wherein power tool 102 includes multiple communication modules for communication with an external device according to different communication protocols.

Authentication module 208 provides cryptographic authentication of a master or user authentication key received via communications module 206. In some examples, authentication module 208 provides hardware authentication of the received keys based on elliptic curve asymmetric cryptography. In some examples, authentication module 208 provides asymmetrical public/private key cryptography with two different keys for encryption and decryption. In some examples, authentication module 208 identifies and authenticates the external device prior to accepting a user key. For example, authentication module 208 may use communications module 206 to exchange one or more cryptographic keys from detachable battery pack 106. Authentication module 208 uses these keys to identify detachable battery pack 106 as a genuine accessory to power tool 102. Authentication module 208 further authenticates detachable battery pack 106 as an external device authorized to provide a master or user key for resetting one of master counter 214 and user counter 216. In some examples, authentication module 208 may allocate different levels of security to different external devices. For example, authentication module 208 may authenticate docking cradle 104 as a device permitted to provide both a master authentication key and a user authentication key for resetting master counter 214 and user counter 216, respectively. Further, authentication module 208 may authenticate detachable battery pack 106 as a device permitted to provide a user authentication key for resetting user counter 216, but not authorize detachable battery pack 106 to provide a master authentication key to reset master counter 214. After authenticating the external device, authentication module 208 authenticates one or more authentication keys received from the external device.

Processors 202, using the authenticated keys, proceeds to reset the corresponding master counter 214 or user counter 216 specified by the authentication keys. In some examples, in response to receiving a valid and authentic master key, processors 202 reset both master counter 214 and user counter 216. In some examples, in response to receiving a valid and authentic master key, processors 202 resets master counter 214 but not user counter 216. In some examples, in response to receiving a valid and authentic user key, processors 202 resets user counter 216 but not master counter 214. In some examples, the master and user authentication keys include information indicating the amount of time to which the corresponding master counter 214 or user counter 216 are to be initialized. In some examples, authentication module 208 permits each user authentication key of a plurality of user authentication keys associated with a plurality of external devices to be used only once per master counter period. In this example, authentication module 208 maintains a list of user keys received from external devices, which is cleared upon receiving a new, valid master key. In this way, authentication module 208 may operate to prevent an unauthorized user in possession of a single valid user key from extending the use time of power tool 102 beyond a single user key session length. In some examples, each master key and user key is unique to the enterprise owning each power tool 102, such that a thief cannot use an authentication key from a first detachable battery pack 106 from a first owner to enable the power tool of a second owner.

After one of master counter 214 or user counter 216 expire, processors 202 disables operation of power tool 102. In one example, processors 202 deactivate power tool 102 by disconnecting motor 210 from its power source 212. In another example, processors 202 may disable power tool 102 by physically decoupling motor 210, by ignoring input commands received via input switch 218, or by disconnecting power, electricity, fuel, or the like from motor 210. In some examples, user counter 216 is initialized to be a duration of a shift, work period, or day, while master counter 214 is initialized to be a duration of a work week, calendar week, or other amount of time longer than user counter 216. In some examples, master counter 214 and user counter 216 are associated with different levels of security or features of power tool 102. For example, when master counter 214 expires, certain features and settings or power tool 102 may be disabled, while when user counter 216 expires, operation of power tool 102 may be disabled.

In one example, master counter 214 is reset by an external device under physical control of the owner of power tool 102, such as docking cradle 104. In this example, at the beginning of a work week, an employee checks power tool 102 out from the inventory of the owner of power tool 104 and removes power tool 102 from docking cradle 104. When power tool 102 is removed, power tool 102 receives, via communications module 206, a master authentication key from docking cradle 104. Authentication module 208 authenticates the master key, causing processors 202 to reset the corresponding master counter 214 and user counter 216 of power tool 102. In this example, the master authentication key is configured to cause processors 202 to initialize master counter 214 to five days and user counter 216 to one day. An employee may further check out one or more detachable battery packs 106A-106C for powering power tool 102.

In this example, while power tool 102 is checked out, processors 202 cause master counter 214 and user counter 216 to decrement. At the work site, the employee connects a first detachable battery pack 106A to power tool 102. Power tool 102 receives, via communications module 206, a first user authentication key from detachable battery pack 106A. Authentication module 208 authenticates the first user key, causing processors 202 to reset user counter 216 but not master counter 214 of power tool 102. When detachable battery pack 102A is drained, the employee connects a second detachable battery pack 106B to power tool 102. Power tool 102 receives, via communications module 206, a second user authentication key from detachable battery pack 106B, causing processors 202 to reset user counter 216. Because the charge of each battery pack 106 is likely to last less than the period of the user counter 216, the employee may continue to use power tool 102 throughout the work day without interruption from the security features of power tool 102. If power tool 102 is stolen from the work site, user counter 216 expires one day (if this was the user programmed operation time) after detachable battery pack 106B is inserted. After user counter 216 expires, processors 202 disable power tool 102, and power tool 102 is inoperable until it receives a new, valid user key from detachable battery pack 106C. As discussed above, in some examples, authentication module 208 disallows the same user key to be used twice in between master counter periods, such that the thief may not use detachable battery pack 106B to reset user counter 216 a second time.

As a further example, if power tool 102 is stolen along with a plurality of detachable battery packs 106, the thief may attempt to use a plurality of user keys associated with detachable battery packs 106 to reset user counter 216 of power tool 102. However, because authentication module 208 does not allow a user key received from detachable battery packs 106 to reset the master counter 214, after one week, master counter 214 will expire. Accordingly, processors 202 disable power tool 102 until authentication module 208 receives a new, valid master key from docking cradle 104. Thus, power tool 102 is rendered inoperable after the master counter 216 expires and may not be used until it is reunited with docking cradle 104. Because docking cradle 104 does not travel to the worksite, but instead is kept within inventory of the owner of power tool 102, it is much less likely to be stolen.

While the description above provides an example scenario involving a construction company implementing the techniques of the disclosure, the techniques as described herein may be beneficial to a wide variety of applications. For example, a hardware store may rent power tools to customers and may benefit from the anti-theft techniques for power tools disclosed herein. Furthermore, an enterprise such as a rental car facility, golf course, tour company, or recreational rental that may rent vehicles such as automobiles, golf carts, a Segway™, recreational vehicles, or electric vehicles. Such an enterprise similarly may benefit from the techniques of the disclosure.

Accordingly, the techniques of the disclosure allow for an owner of a power tool 102 to authorize the use of power tool 102 for a predetermined amount of time and disable power tool 102 after this time expires. Therefore, power tool 102 may deter or prevent theft by rendering power tool 102 useless after a certain amount of time without a secure connection to equipment of the owner to re-enable the functionality of the device. Furthermore, the techniques of the disclosure provide for a software-based system that provides several advantages over other devices. For example, the power tool of the disclosure does not require a small, detachable security device that may be easily lost or misplaced, accelerate wear on the tool, or deposit dirt, water, or contamination into the inner workings of the device. Furthermore, the power tool of the present disclosure may refresh its permissions upon automatically connecting to the external device, and therefore simplifies the implementation of anti-theft procedures by eliminating the involvement of the end-user.

The architecture of power tool 102 illustrated in FIG. 2 is shown as an example. The techniques as set forth in this disclosure may be implemented in the example architecture of FIG. 2, as well as other architectures not described specifically herein. Nothing in this disclosure should be construed so as to limit the techniques of this disclosure to the example architecture illustrated by FIG. 2.

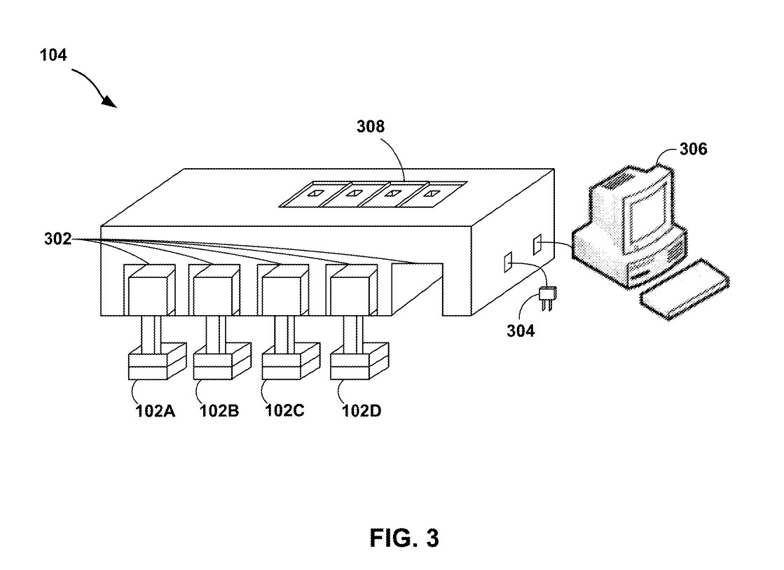

FIG. 3 is an illustration providing further detail of the example docking cradle 104 of FIG. 1 according to the techniques of the disclosure. Docking cradle 104 acts as means for securely and conveniently storing one or more power tools 102A-102D (collectively, “power tools 102”) and one or more detachable battery packs 106 of FIG. 1. In some examples, docking cradle 104 is affixed to a table, wall, or shelf in a secure tool warehouse or storage facility of an enterprise. Docking cradle 104 stores power tools 102 and detachable battery packs 106 until an employee checks out power tools 102 and detachable battery packs 106 for use at a worksite.

Docking cradle 104 includes one or more receptacles 302 for receiving power tools 102. In some examples, receptacle 302 includes a lock or other fastening means for securing power tool 102 to docking cradle 104 such that each of power tools 102 may not be removed without a key. In some examples, docking cradle 104 provides a charging station 308 for recharging one or more detachable battery packs 106 of FIG. 1. In this example, docking cradle further includes an AC adapter 304 for converting electricity to a form suitable to recharge detachable battery packs 106.

In some examples, docking cradle 104 includes an administrator access module 306. Administrator access module 306 is depicted as a computer terminal in FIG. 3, but may also be one or more buttons, a display screen, a plurality of LEDs, or some combination thereof affixed to docking cradle 104. In some examples, administrator access module 306 is a graphical user interface (GUI) or a command line interface (CLI). An administrator may access administrator access module 306 to configure one or more aspects of docking cradle 104, power tools 102 interfaced with docking cradle 104, or detachable battery packs 106 interfaced with docking cradle 104. In some examples, the administrator may configure one or more master or authentication keys associated with power tools 102, docking cradle 104, or detachable battery packs 106, including adjusting security options, passwords, the number of master or user authentication keys, or the length of time for which a master authentication key or user authentication key is valid.

Accordingly, docking cradle 104, as described herein, may securely and conveniently store a plurality of power tools 102 and detachable battery packs 106. Further, docking cradle 104 may provide an efficient and organized means of recharging detachable battery packs 106. Finally, docking cradle 104 may function as a control station to adjust one or more aspects of the master key and user key authentication as implemented according to the techniques of the disclosure. Therefore, docking cradle 104 may deter or prevent theft by rendering power tools 102 useless after a certain amount of time without a secure connection to docking cradle 104 to re-enable the functionality of the device.

The architecture of docking cradle 104 illustrated in FIG. 3 is shown as an example. The techniques as set forth in this disclosure may be implemented in the example architecture of FIG. 3, as well as other architectures not described specifically herein. Nothing in this disclosure should be construed so as to limit the techniques of this disclosure to the example architecture illustrated by FIG. 3.

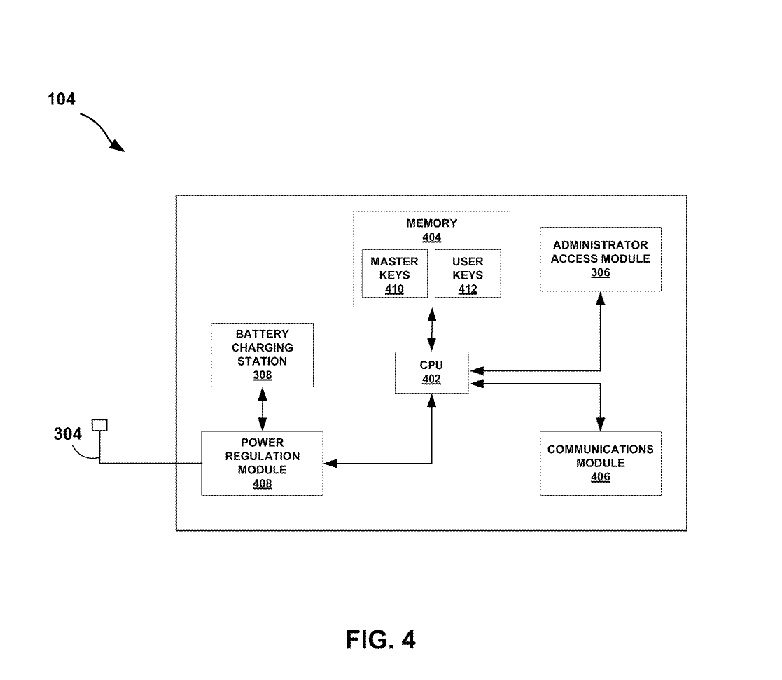

FIG. 4 is a block diagram providing further detail of the example docking cradle 104 of FIG. 1 according to the techniques of the disclosure. In one example, docking cradle 104 stores a table of master authentication keys 410 and a table of user authentication keys 412 in memory 404. An administrator may access administrator access module 306 to configure one or more aspects of docking cradle 104, power tools 102 interfaced with docking cradle 104, or detachable battery packs 106 interfaced with docking cradle 104, including master authentication keys 410 and user authentication keys 412. Docking cradle 412 further includes battery charging station 308, which recharges one or more detachable battery packs 106 of FIG. 1.

In some examples, docking cradle includes one or more processors 402. Processors 402 may be microprocessors, digital signal processors (DSPs), application specific integrated circuits (ASICs), field programmable gate arrays (FPGAs), or any other equivalent integrated or discrete logic circuitry, as well as any combinations of such components. Further, memory 404 may be random access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. Further, this memory may be implanted entirely in hardware, software, or a combination thereof.

Memory 404 includes a table of master authentication keys 410 and a table of user authentication keys 412. In some examples, each master key and user key stored in memory 404 is a unique cryptographic key. In some examples, each key is unique to the docking cradle or to the enterprise owning power tools 102, such that a key stored by a first docking cradle may not be used to reset the operability of a power tool 102 associated with a second enterprise.

In some examples, docking cradle 308 includes a battery charging station 308 for recharging one or more detachable battery packs 106. Battery charging station 308 receives electricity from power regulation module 408, which converts electricity received via AC adaptor 304 into a form suitable for battery charging station 308 to recharge detachable battery packs 106. In some examples, power regulation module 408 performs voltage conversion functions on power received from the AC supply to supply a first voltage or current to processors 402 and a second voltage or current to battery charging station 308. In some examples, power regulation module 408 further includes power regulation circuitry to safely recharge detachable battery packs 106. For example, battery charging station 308 and power regulation module 408 operate to electrically isolate detachable battery packs 106 from the AC supply and to detect short circuits, overheating, or oversupply of electrical current or voltage in detachable battery packs 106. In some examples, battery charging station 308 and power regulation module 408 protect detachable battery packs 106 from damage by decoupling them from power in response to determining that detachable battery packs 106 is overheating, receiving overcurrent, or otherwise operating in an unsafe or unintended manner.

In some examples, docking cradle 104 includes a communication module 406. Communication module 406 includes any suitable circuitry, firmware, software, or any combination thereof for communicating with another device, such as detachable battery pack 106 or power tool 102 of FIG. 1. In some examples, communication module 406 connects to the device via a wired or a wireless connection. For example, communication module 406 may include one or more antennae, modulation and demodulation circuitry, filters, amplifiers, or the like for radio frequency communication with other external devices, such as detachable battery pack 106 or power tool 102. Under the control of processors 402, communication module 406 may receive downlink telemetry from and send uplink telemetry to a device with the aid of an antenna, which may be internal and/or external. Processors 402 may provide the data to be uplinked to the device and the control signals for the telemetry circuit within communication module 406, e.g., via an address/data bus. In some examples, communication module 406 provides received data to processors 402 via a multiplexer, e.g., for example, in implementations wherein docking cradle 104 includes multiple communication modules for communication with power tool 102 and detachable battery pack 106 according to different communication protocols.

In some examples, when detachable battery pack 106 docks with battery charging station 308, processors 402 assign a unique user authentication key from table of user authentication keys 412 to the detachable battery pack 106. Processors 402 transmit, via communications module 406, the unique user authentication key to the detachable battery pack 106 for subsequent use when detachable battery pack 106 is affixed to power tool 102. Further, processors 402 transmit, via communications module 406, a master key from table of master keys 410 to power tool 102 to reset the master counter 214 and user counter 216 associated with the power tool 102. In some examples, processors 402 transmit, via communications module 406, the master key to power tool 102 when power tool 102 is inserted into receptacle 302 of docking cradle 104. In other examples, processors 402 transmit, via communications module 406, the master key to power tool 102 when power tool 102 is removed from receptacle 302 or when power tool 102 is within a predetermined range of docking cradle 104.

Accordingly, docking cradle 104, as described herein, may securely and conveniently store a plurality of power tools 102 and detachable battery packs 106. Further, docking cradle 104 may provide an efficient and organized means of recharging detachable battery packs 106. Finally, docking cradle 104 may function as a control station to adjust one or more aspects of the master key and user key authentication as implemented according to the techniques of the disclosure. Therefore, docking cradle 104 may deter or prevent theft by rendering power tools 102 useless after a certain amount of time without a secure connection to docking cradle 104 to re-enable the functionality of the device.

The architecture of docking cradle 104 illustrated in FIG. 4 is shown as an example. The techniques as set forth in this disclosure may be implemented in the example architecture of FIG. 4, as well as other architectures not described specifically herein. Nothing in this disclosure should be construed so as to limit the techniques of this disclosure to the example architecture illustrated by FIG. 4.

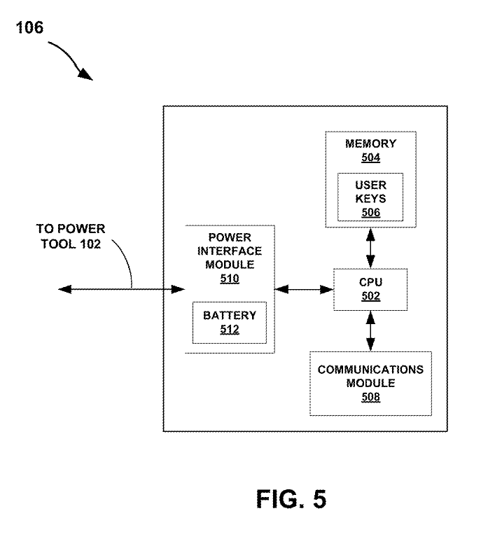

FIG. 5 is a block diagram providing further detail of the example detachable battery pack 106 of FIG. 1 according to the techniques of the disclosure. According to the techniques of the disclosure, detachable battery pack 106 includes a memory 504 that stores at least one user authentication key 506. When coupled to the power tool 102 of FIG. 1, detachable battery pack 106 transmits, via communications module 508, the user key 506 to the power tool 102.

In some examples, docking cradle includes one or more processors 502. Processors 502 may be microprocessors, digital signal processors (DSPs), application specific integrated circuits (ASICs), field programmable gate arrays (FPGAs), or any other equivalent integrated or discrete logic circuitry, as well as any combinations of such components. Further, memory 504 may be random access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. Further, this memory may be implanted entirely in hardware, software, or a combination thereof. Memory 504 includes at least one user authentication key 506. In some examples, each user authentication key stored in memory 504 is unique to detachable battery pack 106.

In some examples, detachable battery pack 106 includes a power interface module 510. Power interface module 510 functions to supply power, via battery 512, to power tool 102. In some examples, power interface module 510 further includes power regulation circuitry to safely regulate the discharge and recharge of detachable battery pack 106. For example, power interface module 510 operates to electrically isolate detachable battery pack 106 from power tool 102 or a recharger. Power interface module 510 further operates to detect short circuits, overheating, or oversupply of electrical current or voltage in detachable battery pack 106. In some examples, power interface module 510 protects detachable battery pack 106 from damage by decoupling them from a load or supply in response to determining that detachable battery pack 106 is overheating, receiving overcurrent, or otherwise operating in an unsafe or unintended manner. Power interface module 510 further includes a medium for storing energy to be supplied to power tool 102, such as battery 512. Battery 512 may be any form of battery, such as an Alkaline, Zinc-Carbon, Lead-Acid, Mercury, Lithium Ion, Lithium Polymer, Silver Oxide, Nickel-Cadmium, Nickel-Metal Hydride, or Nickel-Zinc battery.

In some examples, detachable battery pack 106 includes a communication module 508. Communication module 508 includes any suitable circuitry, firmware, software, or any combination thereof for communicating with another device, such as docking cradle 104 or power tool 102 of FIG. 1. In some examples, communication module 508 connects to the device via a wired or a wireless connection. For example, communication module 508 may include one or more antennae, modulation and demodulation circuitry, filters, amplifiers, or the like for radio frequency communication with other external devices, such as docking cradle 104 or power tool 102. Under the control of processors 502, communication module 508 may receive downlink telemetry from and send uplink telemetry to a device with the aid of an antenna, which may be internal and/or external. Processors 508 may provide the data to be uplinked to the device and the control signals for the telemetry circuit within communication module 508, e.g., via an address/data bus. In some examples, communication module 508 provides received data to processors 502 via a multiplexer, e.g., for example, in implementations wherein detachable battery pack 106 includes multiple communication modules for communication with power tool 102 and docking cradle 104 according to different communication protocols.

In some examples, when detachable battery pack 106 is connected to power tool 102, processors 502, via communications module 508, transmit authentication information sufficient to authenticate detachable battery pack 106 as a device authorized to provide user authorization keys to power tool 102. Upon proper authorization, processors 502, via communications module 508, transmit user authentication key 506 stored in memory 504 to power tool 102. In response to validating user authentication key 506, power tool 102 resets user counter 216 for a period of time specified by user authorization key 506.

As described above, the techniques of the disclosure allow for a power tool to provide anti-theft procedures by disabling itself after the expiration of one or more master counters and user counters. However, the techniques of the disclosure may be implemented in accessories of power tool 102, such as detachable battery pack 106. For example, instead of including the anti-theft functionality of the disclosure, such as master counter 214, user counter 216, and authentication module 208, in power tool 102, the functionality may instead be included in detachable battery pack 106. In this example, upon expiration of a master counter or user counter included within detachable battery pack 106, detachable battery pack 106 may disable power tool 102 by disabling power supplied via battery 512 to power tool 102. Further, docking cradle 104 operates to reset the counters of detachable battery pack 106, restoring detachable battery pack 106 to use.

Accordingly, the techniques of the disclosure allow for an owner of a power tool 102 to authorize the use of power tool 102 for a predetermined amount of time and disable power tool 102 after this time expires. Therefore, power tool 102 may deter or prevent theft by rendering power tool 102 useless after a certain amount of time without a secure connection to equipment of the owner, such as detachable battery pack 106, to re-enable the functionality of the device. Furthermore, the techniques of the disclosure provide for a software-based system that provides several advantages over other devices. For example, the power tool 102 of the disclosure does not require a small, detachable security device that may be easily lost or misplaced, accelerate wear on the tool, or deposit dirt, water, or contamination into the inner workings of the device. Furthermore, the power tool 102 of the present disclosure may refresh its permissions upon automatically connecting to the external device, such as detachable battery pack 106, and therefore simplifies the implementation of anti-theft procedures by eliminating the involvement of the end-user or operator.

The architecture of detachable battery pack 106 illustrated in FIG. 5 is shown as an example. The techniques as set forth in this disclosure may be implemented in the example architecture of FIG. 5, as well as other architectures not described specifically herein. Nothing in this disclosure should be construed so as to limit the techniques of this disclosure to the example architecture illustrated by FIG. 5.

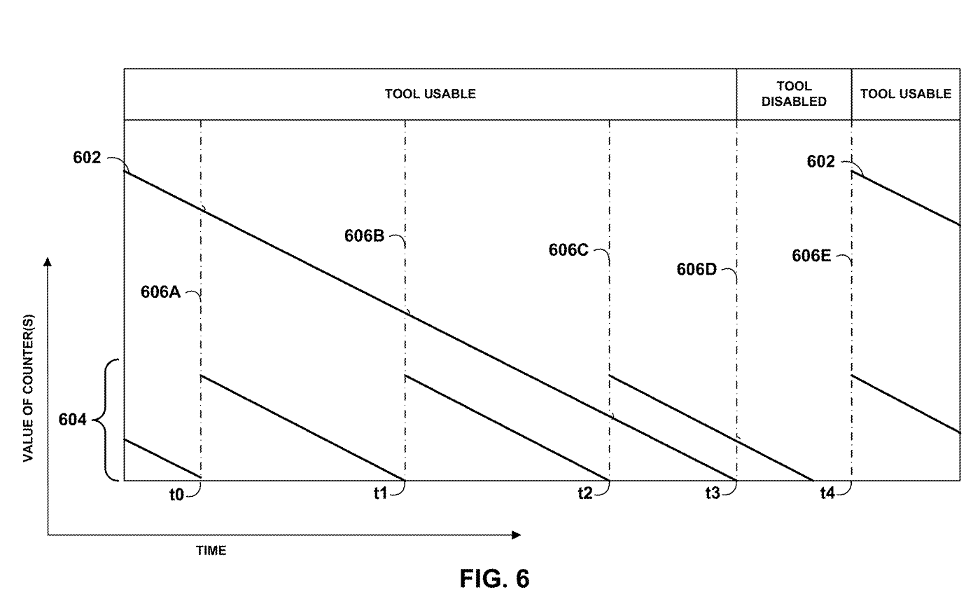

FIG. 6 is a graph illustrating an example operation for providing anti-theft techniques for the power tool 102 of FIG. 1 according to the techniques of the disclosure. In the example operation of FIG. 6, power tool 106 includes a master counter 214 having a value 602 and a user counter 216 having a value 604. While the master counter 214 and the user counter 216 are greater than zero, power tool 102 functions normally. Processors 202 decrement master counter 214 and user counter 216 during the operation of power tool 102, such that, when either of the counters expire, processors 202 disable power tool 102 until the counters are reset. Upon receiving a valid master authentication key or user authentication key from an external device, such as docking cradle 104 or detachable battery pack 106, processors 202 reset one or both of master counter 214 and the user counter 216 and re-enable power tool 102.

As depicted in FIG. 6, as time progresses, the value 602 of master counter 214 and the value 604 of user counter 216 decrease. At each of time=t0, t1, and t2, the user counter 216 reaches zero, and processors 202 disable power tool 102. The operator replaces a first detachable battery pack 106 inserted within power tool 102 with a second detachable battery pack 106 having an unused user authentication key. The second detachable battery pack 106 transmits the user authentication key to power tool 102, causing processors 202 to reset user counter 216 and re-enable operation of power tool 102. However, at time=t3, the value 602 of master counter 214 reaches zero, causing processors 202 disable power tool 102. At this time, power tool 102 is rendered inoperable, even though the value 604 of user counter 216 is greater than zero. Further, any additional user authentication keys transmitted to power tool 102 will not render power tool operable again. Power tool 102 remains inoperable until it is returned to docking cradle 104 at time=t4. At this time, docking cradle 104 transmits a master authentication key to power tool 102, causing processors 202 to reset the value 602 of master counter 214 and the value 604 of user counter 216 and re-enable use of power tool 102.

Accordingly, the techniques of the disclosure allow for power tool 102 to disable itself after a predetermined amount of time and prevent further use without further authorization from the owner. Therefore, power tool 102 may deter or prevent theft by rendering power tool 102 useless after a certain amount of time without a secure connection to equipment of the owner to re-enable the functionality of the device. Furthermore, the techniques of the disclosure provide for a software-based system that provides several advantages over other devices. For example, the power tool 102 of the disclosure does not require a small, detachable security device that may be easily lost or misplaced, accelerate wear on the tool, or deposit dirt, water, or contamination into the inner workings of the device. Furthermore, the power tool 102 of the present disclosure may refresh its permissions upon automatically connecting to the external device, and therefore simplifies the implementation of anti-theft procedures by eliminating the involvement of the end-user.

The operation of power tool 102 illustrated in FIG. 6 is shown as an example. The techniques as set forth in this disclosure may be implemented in the example operation of FIG. 6, as well as other operations not described specifically herein. Nothing in this disclosure should be construed so as to limit the techniques of this disclosure to the example operation illustrated by FIG. 6.

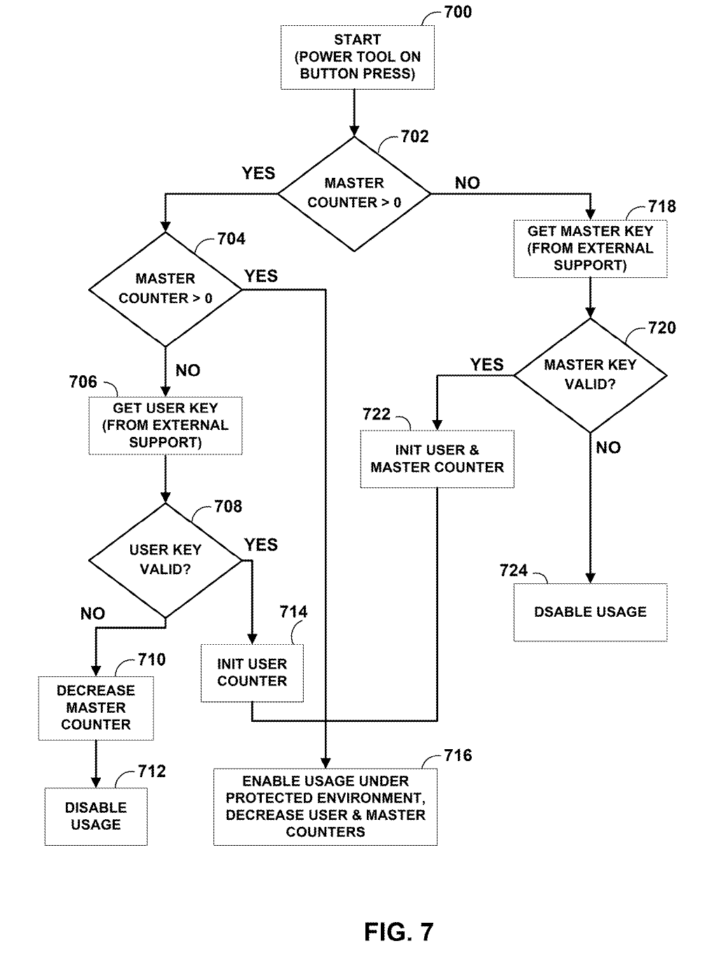

FIG. 7 is a flowchart illustrating an example operation for providing anti-theft techniques for power tool 102 of FIG. 2 according to the techniques of the disclosure. For convenience, FIG. 7 is described with respect to FIG. 2. However, the example operation of FIG. 7 is not limited to FIG. 2, but instead applies generally to the techniques of the disclosure.

In one example, an operator depresses input switch 218 to activate power tool 102 (700). In one example, input switch 218 is a pistol-grip trigger for activating power tool 102. Processors 202 receive the input command and determine if master counter 214 has expired (702). If master counter 214 has not expired, processors 202 determine if the user counter 216 has expired (704). Upon determining that both the master counter 214 and user counter have not expired, processors 202 enable operation of power tool 102 (716). In some examples, processors 202 enable operation of power tool 102 by connecting power module 212 to motor 210.

Upon determining that user counter 216 has expired, processors 202 attempt to retrieve a user authentication key from an external device, such as docking cradle 104 or detachable battery pack 106 (706). In some examples, processors 202 issue an open request via communications module 206 and listen for a response from a nearby external device. In one example, detachable battery pack 106 issues a response. Authentication module 208 authenticates detachable battery pack 106 as a device authorized to provide user authentication keys. Upon being authenticated, detachable battery pack 106 provides a user authentication key to power tool 102 (708). If authentication module 208 determines that the user authentication key is invalid, processors 202 decrement the master counter 214 (710). Further, processors 202 disable operation of power tool 102 because user counter 216 has expired and power tool 102 was unable to reinitialize user counter 216 due with a valid user authentication key (712). In this scenario, power tool 202 is disabled until power tool 202 receives a valid user authentication key. If authentication module 208 determines that the user authentication key is valid, processors 202 reset user counter 216 (714). Furthermore, processors 202 enable continued operation of power tool 102 (716).

If processors 202 determine that the master counter 214 has expired, processors 202 attempt to retrieve a master authentication key from an external device, such as docking cradle 104 or detachable battery pack (718). In some examples, processors 202 issue an open request via communications module 206 and listen for a response from a nearby external device. In one example, docking cradle 104 issues a response. Authentication module 208 authenticates docking cradle 104 as a device authorized to provide master authentication keys. Upon being authenticated, docking cradle 104 provides a master authentication key to power tool 102 (720). If authentication module 208 determines that the master authentication key is invalid, processors 202 disable operation of power tool 102 because master counter 214 has expired and power tool 102 was unable to reinitialize master counter 214 due with a valid master authentication key (724). In this scenario, power tool 202 is disabled until power tool 202 receives a valid master authentication key. If authentication module 208 determines that the master authentication key is valid, processors 202 reset both master user counter 214 and user counter 216 (722). Furthermore, processors 202 enable continued operation of power tool 102 (716).

Accordingly, the techniques of the disclosure allow for an owner of a power tool 102 to authorize the use of power tool 102 for a predetermined amount of time and disable power tool 102 after this time expires. Therefore, power tool 102 may deter or prevent theft by rendering power tool 102 useless after a certain amount of time without a secure connection to equipment of the owner to re-enable the functionality of the device. Furthermore, the techniques of the disclosure provide for a software-based system that provides several advantages over other devices. For example, the power tool of the disclosure does not require a small, detachable security device that may be easily lost or misplaced, accelerate wear on the tool, or deposit dirt, water, or contamination into the inner workings of the device. Furthermore, the power tool of the present disclosure may refresh its permissions upon automatically connecting to the external device, and therefore simplifies the implementation of anti-theft procedures by eliminating the involvement of the end-user.

The operation of power tool 102 illustrated in FIG. 7 is shown as an example. The techniques as set forth in this disclosure may be implemented in the example operation of FIG. 7, as well as other operations not described specifically herein. Nothing in this disclosure should be construed so as to limit the techniques of this disclosure to the example operation illustrated by FIG. 7.

The following examples may illustrate one or more aspects of the disclosure.

### Example 1

A method, comprising: receiving, by at least one processor of a power tool and from an operator, a command to operate the power tool; in response to receiving the command, determining, by the at least one processor, whether at least one of a value of a master authentication counter of the power tool and a value of a user authentication counter of the power tool has reached a predetermined threshold; and in response to determining that the at least one of the value of the master authentication counter and the value of the user authentication counter has reached a predetermined threshold, disabling, by the at least one processor, the power tool.

### Example 2

The method of example 1, further comprising: receiving, by the at least one processor and from a first external device configured to store a master software key in a first memory, the master software key; validating, by the at least one processor, the master software key; and in response to validating the master software key, resetting, by the at least one processor, the value of the master authentication counter and the value of the user authentication counter.

### Example 3

The method of any of examples 1-2, further comprising: receiving, by the at least one processor and from a second external device configured to store a user software key in a second memory, the user software key; validating, by the at least one processor, the user software key; and in response to validating the user software key, resetting, by the at least one processor, the value of the user authentication counter but not the value of the master authentication counter.

### Example 4

The method of any of examples 1-3, further comprising: adjusting the value of the master authentication counter after a first predetermined amount of time has elapsed; and adjusting the value of the user authentication counter after a second predetermined amount of time has elapsed, wherein the second predetermined amount of time is less than the first predetermined amount of time.

### Example 5

The method of any of examples 1-4, wherein the first external device is a docking cradle configured to receive the power tool.

### Example 6

The method of any of examples 1-5, wherein the second external device is a detachable battery pack configured to couple to the power tool.

### Example 7

The method of any of examples 1-6, wherein receiving, from the first external device, the master software key comprises receiving, from the first external device via a wireless connection, the master software key.

### Example 8

A power tool, comprising: a memory, configured to store a value of a master authentication counter and a value of a user authentication counter; and at least one processor configured to: receive, from an operator, a command to operate the power tool; in response to receiving the command, determine whether at least one of the value of the master authentication counter and the value of the user authentication counter has reached a predetermined threshold; and in response to determining that the at least one of the value of the master authentication counter and the value of the user authentication counter has reached a predetermined threshold, disable the power tool.

### Example 9

The power tool of example 8, wherein the at least one processor is further configured to: receive, from a first external device configured to store a master software key in a first memory, the master software key; validate the master software key; and in response to validating the master software key, reset the value of the master authentication counter and the value of the user authentication counter.

### Example 10

The power tool of any of examples 8-9, wherein the at least one processor is further configured to: receive, from a second external device configured to store a user software key in a second memory, the user software key; validate, the user software key; and in response to validating the user software key, reset the value of the user authentication counter but not the value of the master authentication counter.

### Example 11

The power tool of any of examples 8-10, wherein the at least one processor is further configured to: adjust the value of the master authentication counter after a first predetermined amount of time has elapsed; and adjust the value of the user authentication counter after a second predetermined amount of time has elapsed, wherein the second predetermined amount of time is less than the first predetermined amount of time.

### Example 12

The power tool of any of examples 8-11, wherein the first external device is a docking cradle configured to receive the power tool.

### Example 13

The power tool of any of examples 8-12, wherein the second external device is a detachable battery pack configured to couple to the power tool.

### Example 14

The power tool of any of examples 8-13, wherein the at least one processor configured to receive, from the first external device, the master software key is further configured to receive, from the first external device via a wireless connection, the master software key.

### Example 15

A system, comprising: a power tool, comprising: a memory, configured to store a value of a master authentication counter and a value of a user authentication counter; and at least one processor configured to: receive, from an operator, a command to operate the power tool; in response to receiving the command, determine whether at least one of the value of the master authentication counter and the value of the user authentication counter has reached a predetermined threshold; and in response to determining that the at least one of the value of the master authentication counter and the value of the user authentication counter has reached a predetermined threshold, disable the power tool; a first external device configured to: store a master software key in a first memory; and transmit the master software key to the power tool; wherein the at least one processor of the power tool is further configured to: receive the master software key; validate the master software key; and in response to validating the master software key, reset the value of the master authentication counter and the value of the user authentication counter; and a second external device configured to: store a user software key in a second memory; and transmit the user software key to the power tool; wherein the at least one processor of the power tool is further configured to: receive the user software key; validate the user software key; and in response to validating the user software key, reset the value of the user authentication counter but not the value of the master authentication counter.

### Example 16

The system of example 15, wherein the at least one processor is further configured to: receive, from a first external device configured to store a master software key in a first memory, the master software key; validate the master software key; and in response to validating the master software key, reset the value of the master authentication counter and the value of the user authentication counter.

### Example 17

The system of any of examples 15-16, wherein the at least one processor is further configured to: receive, from a second external device configured to store a user software key in a second memory, the user software key; validate, the user software key; and in response to validating the user software key, reset the value of the user authentication counter but not the value of the master authentication counter.

### Example 18

The system of any of examples 15-17, wherein the at least one processor is further configured to: adjust the value of the master authentication counter after a first predetermined amount of time has elapsed; and adjust the value of the user authentication counter after a second predetermined amount of time has elapsed, wherein the second predetermined amount of time is less than the first predetermined amount of time.

### Example 19

The system of any of examples 15-18, wherein the first external device is a docking cradle configured to receive the power tool.

### Example 20

The system of any of examples 15-19, wherein the second external device is a detachable battery pack configured to couple to the power tool.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

What is claimed is:

1. A method, comprising:
receiving, by at least one processor of a power tool and from an operator, a command to operate the power tool;
in response to receiving the command, determining, by the at least one processor, whether at least one of a value of a master authentication counter of the power tool and a value of a user authentication counter of the power tool has reached a predetermined threshold; and
in response to determining that the at least one of the value of the master authentication counter and the value of the user authentication counter has reached a predetermined threshold, disabling, by the at least one processor, the power tool.

2. The method of claim 1, further comprising:
receiving, by the at least one processor and from a first external device configured to store a master software key in a first memory, the master software key;
validating, by the at least one processor, the master software key; and
in response to validating the master software key, resetting, by the at least one processor, the value of the master authentication counter and the value of the user authentication counter.

3. The method of claim 1, further comprising:
receiving, by the at least one processor and from a second external device configured to store a user software key in a second memory, the user software key;
validating, by the at least one processor, the user software key; and
in response to validating the user software key, resetting, by the at least one processor, the value of the user authentication counter but not the value of the master authentication counter.

4. The method of claim 1, further comprising:
adjusting the value of the master authentication counter after a first predetermined amount of time has elapsed; and
adjusting the value of the user authentication counter after a second predetermined amount of time has elapsed, wherein the second predetermined amount of time is less than the first predetermined amount of time.

5. The method of claim 2, wherein the first external device is a docking cradle configured to receive the power tool.

6. The method of claim 3, wherein the second external device is a detachable battery pack configured to couple to the power tool.

7. The method of claim 1, wherein receiving, from the first external device, the master software key comprises receiving, from the first external device via a wireless connection, the master software key.

8. A power tool, comprising:
a memory, configured to store a value of a master authentication counter and a value of a user authentication counter; and
at least one processor configured to:
receive, from an operator, a command to operate the power tool;
in response to receiving the command, determine whether at least one of the value of the master authentication counter and the value of the user authentication counter has reached a predetermined threshold; and
in response to determining that the at least one of the value of the master authentication counter and the value of the user authentication counter has reached a predetermined threshold, disable the power tool.

9. The power tool of claim 8, wherein the at least one processor is further configured to:
receive, from a first external device configured to store a master software key in a first memory, the master software key;
validate the master software key; and
in response to validating the master software key, reset the value of the master authentication counter and the value of the user authentication counter.

10. The power tool of claim 8, wherein the at least one processor is further configured to:
receive, from a second external device configured to store a user software key in a second memory, the user software key;
validate, the user software key; and
in response to validating the user software key, reset the value of the user authentication counter but not the value of the master authentication counter.

11. The power tool of claim 8, wherein the at least one processor is further configured to:
adjust the value of the master authentication counter after a first predetermined amount of time has elapsed; and
adjust the value of the user authentication counter after a second predetermined amount of time has elapsed, wherein the second predetermined amount of time is less than the first predetermined amount of time.

12. The power tool of claim 9, wherein the first external device is a docking cradle configured to receive the power tool.

13. The power tool of claim 10, wherein the second external device is a detachable battery pack configured to couple to the power tool.

14. The power tool of claim 8, wherein the at least one processor configured to receive, from the first external device, the master software key is further configured to receive, from the first external device via a wireless connection, the master software key.

15. A system, comprising:
a power tool, comprising:
a memory, configured to store a value of a master authentication counter and a value of a user authentication counter; and
at least one processor configured to:
receive, from an operator, a command to operate the power tool;
in response to receiving the command, determine whether at least one of the value of the master authentication counter and the value of the user authentication counter has reached a predetermined threshold; and
in response to determining that the at least one of the value of the master authentication counter and the value of the user authentication counter has reached a predetermined threshold, disable the power tool;
a first external device configured to:
store a master software key in a first memory; and
transmit the master software key to the power tool;
wherein the at least one processor of the power tool is further configured to:
receive the master software key;
validate the master software key; and
in response to validating the master software key, reset the value of the master authentication counter and the value of the user authentication counter; and
a second external device configured to:
store a user software key in a second memory; and
transmit the user software key to the power tool;
wherein the at least one processor of the power tool is further configured to:
receive the user software key;
validate the user software key; and
in response to validating the user software key, reset the value of the user authentication counter but not the value of the master authentication counter.

16. The system of claim 15, wherein the at least one processor is further configured to:
receive, from a first external device configured to store a master software key in a first memory, the master software key;
validate the master software key; and
in response to validating the master software key, reset the value of the master authentication counter and the value of the user authentication counter.

17. The system of claim 15, wherein the at least one processor is further configured to:
receive, from a second external device configured to store a user software key in a second memory, the user software key;
validate, the user software key; and
in response to validating the user software key, reset the value of the user authentication counter but not the value of the master authentication counter.

18. The system of claim 15, wherein the at least one processor is further configured to:
adjust the value of the master authentication counter after a first predetermined amount of time has elapsed; and
adjust the value of the user authentication counter after a second predetermined amount of time has elapsed, wherein the second predetermined amount of time is less than the first predetermined amount of time.

19. The system of claim 15, wherein the first external device is a docking cradle configured to receive the power tool.

20. The system of claim 15, wherein the second external device is a detachable battery pack configured to couple to the power tool.
